(19) United States
(12) Patent Application Publication
(10) Pub. No.: US 2003/0102956 A1
(43) Pub. Date: Jun. 5, 2003

(54) Queuing system and methods

(76) Inventors: Jeff McManus, Gerrards Cross (GB); Leonard Sim, Wokingham (GB)

Correspondence Address: NEEDLE & ROSENBERG P C, 127 PEACHTREE STREET N E, ATLANTA, GA, 30303-1811, US

(21) Appl. No.: 10/277,231

(22) Filed: Oct. 21, 2002

Related U.S. Application Data
(60) Provisional application No. 60/346,261, filed on Oct. 19, 2001.

(51) Int. Cl. H04Q 1/00

(52) U.S. Cl. 340/5.2

(57) ABSTRACT

A queue control system, and queuing methods for use therewith are disclosed. The queuing system allocates a sequential series of places in a single queue line for an attraction to each patron or group of patrons as they enter the queue. The system permits any one or identified group of patrons to be virtually present or otherwise qualified in the queue as if they are physically present in the queue although they may in fact be physically absent from the queue by retaining the patron's place in the queue through the provision of a virtual position in the queue line or sequence until the patron's position is due to reach the head of that queue line. The system also makes provision for charging the patrons a premium for using designated attractions during predetermined time periods, as well as permitting the patrons to accelerate their progress through the attraction queue therefor.

### CROSS REFERENCE TO RELATED APPLICATION

This application claims priority to provisional U.S. Patent Application Serial No. 60/346,261, filed on Oct. 19, 2001, in the United States Patent and Trademark Office, which application is incorporated fully herein by this reference.

### FIELD OF THE INVENTION

The present invention relates in general to queuing systems and methods of using same. More particularly, the present invention relates to an automated queuing system, and methods of use thereof, adapted for maintaining a single queue line for an attraction within which the patrons may be either physically or virtually present, and for managing queues for maximum efficiency.

### BACKGROUND OF THE INVENTION

As known, whenever there is an event or attraction of great popularity, for example a new attraction or a ride at an amusement park, a great many people are desirous of attending the event or riding the attraction. What this requires in addition to the price of admission therefor is that the participants desiring to enter the event or attraction must wait in a long and sometimes slow moving physical queue line as their place in the queue eventually moves through the attraction queue line until it is their turn to participate in the event or attraction.

Although this may not be too burdensome in isolated instances, it is becoming commonplace, and especially so in amusement parks, for people to spend a great deal of time in a queue line in order to ride on a single popular existing or new attraction, respectively. This has resulted in the formation of a number of relatively long and slow moving queue lines, one for each attraction, as far more time is generally spent moving people through the queue line leading to the attraction in contrast to the actual amount of time the amusement park customers spend riding the attraction. The inevitable result of this is that a great deal of the amusement park customer's time is spent waiting in a queue line with nothing else to do. This becomes quite problematic if, for example, the customer needs to leave the queue line to attend to the needs of a small child that requires prompt attention such that the customer, or a group of customers, will lose their place in the line after attending to the needs of the party, and will only become even more frustrated at the prospect of having to start over again at the back of the line.

The known queue management systems typically use two queue lines. A first queue line for those patrons who are willing to spend their waiting time by physically standing in a line at the target attraction, and either a second “virtual” queue line which is determined by and stored within the memory of a computer, for example, or a second physical queue line controlled through special attraction/event tickets. Examples of known virtual queue management systems are disclosed in U.S. Pat. No. 5,987,421 to Chuang; U.S. Pat. No. 5,502,806 to Mahoney et al.; and U.S. Pat. No. 6,173, 209 to Laval et al.

The algorithms used to calculate the virtual positions of the patrons in the virtual queue for the known queuing systems carry the risk that the rate of progress between the real queue and the virtual queue may become unsynchronized due to differences between the predicted and actual demands of patrons, and the ability of the attraction to take patrons if, for example, the attraction has an unscheduled maintenance stop or a weather delay. This may lead to dissatisfaction among the patrons waiting in the physical queue, and to a dispute between the patrons in the physical queue and those in the virtual queue, particularly if the patrons in the physical queue are already feeling frustrated after a long wait in their respective queue. As every attraction is potentially subject to unforeseen delays, the existing queue management systems allow the possibility that any such delays may lead to the possibility of the patrons within the virtual queue taking all of the available spaces on the attraction, thus causing the real or physical queue to come to a halt.

What is needed, therefore, is a simple, and flexible queuing system that will meet the many and varied needs of both the event/attraction proprietor and the customers thereof, in both public and private venues attended or otherwise populated by large numbers of people competing for the proprietor's goods or services. Toward this end, what is also needed is a queue control system and methods which allocate a queue position to a patron and reserve a place for that patron without requiring the patron's physical presence in the queue until shortly before boarding the attraction or attending the event.

### SUMMARY OF THE INVENTION

In a first aspect of the invention, a queue control system is provided which allocates a sequential series of places in a single queue line for the attraction to each patron or group of patrons as they enter the queue. The system permits any one or identified group of patrons to be virtually present or otherwise qualified in the queue as if they are physically present in the queue while they are in fact physically absent from the queue by retaining the patron's place in the queue through the provision of a virtual position in the queue line or sequence until the patron's position is due to reach the head of that queue line.

Toward this end, the queuing system includes a token for each patron admitted to the venue, each token having a unique identifier associated therewith, a first scanner positioned at an entrance to the attraction and which is constructed and arranged to detect and read the token of each patron passing through the entrance to the attraction, a second scanner positioned at a the final assembly (boarding) area of the attraction and which is constructed and arranged to detect and read the token of each patron passing into the final assembly area of the attraction. The system also has a third scanner positioned at an exit from the attraction, the third scanner also being constructed and arranged to detect and read the token of each patron passing from the attraction, and a queuing system computer in communication with each of the scanners.

The queuing system computer is programmed to assign each successive patron of the attraction a sequential place in a single queue line maintained for the attraction in response to the scanning of the patron tokens by the first scanner. The queuing system computer is also programmed to dynamically track the progress of each patron through the queue line of the attraction, and to calculate the time required for the patron to pass from the entrance of the attraction through the queue and into the final assembly area of the attraction. To assist in the tracking function, the system also has at least one fourth scanner positioned intermediate the first and the second scanners, respectively, and with respect to (along) the attraction queue line, the at least fourth scanner also being in communication with the queuing system computer and constructed and arranged to detect and read the token of each patron passing thereby.

The system also includes a video display at the attraction, the video display being in communication with the queuing system computer and adapted to display information to the patrons of the attraction. Additionally, the system may also include a wireless local area network (LAN) within the venue, the local area network being in communication with a control computer, the control computer being in communication with the queuing system computer, and at least one wireless personal tracking and communications device for use by at least one of the respective patrons of the venue. The communications devices are each constructed and arranged to be in communication with the control computer through the local area network, and to emit a signal adapted to be detected and read by each of the aforementioned scanners as well as for the local area network, throughout the venue.

The queuing system computer assigns the at least one patron using one of the communications devices with a virtual place in the single queue line maintained for that attraction when that patron's communications device is scanned at the entrance to the attraction, and in association with the control computer and the LAN, tracks the progress of the at least one patron using one of the communications devices through the queue line whether the patron is present in the queue or located elsewhere within the venue. If the patron is absent from the queue, the system holds the patron's virtual place in the queue line for the attraction.

Moreover, the system may be constructed to notify the at least one patron, through the LAN, of the patron's estimated time to re-enter the queue line in order to enter the final assembly area of the attraction. This is accomplished by the system polling the LAN for the at least one patron's communications device, determining the location of the patron within the venue with respect to the attraction, and forwarding this information to the queuing system computer, the queuing system computer then determining the time needed for the patron to return to the attraction and their place in the queue line and notifying the patron of this fact in advance of the time the patron needs to re-enter the queue line in order to enter the final assembly area for the attraction.

Accordingly, the system of this invention logs each patron into their proper sequential position in a single queue for the attraction, that position being absolutely dependent on the time at which the patron logs into the queue line. Such logging-in may be accomplished by physically arriving at the tail end of the physical queue (at the first scanner) and booking into the system, or at a suitably equipped booking station located either at the attraction or elsewhere with respect thereto and adapted to read the patron's wireless communication device, if so rented by the patron. This therefore minimizes the causes of disagreement between patrons in the respective physical and virtual queue lines for the attraction.

In a second aspect of the system, a queue control system is provided which enables the proprietors of the attraction or the event for which the patrons are in a queue line to balance the length of the respective queue lines for any and all associated attractions or events across periods of high and low demand. This is accomplished by transmitting through the LAN, to those patrons in possession of a communications device, a notice of a premium charge period during which a premium will be charged, or a credit given, to a patron for their use of predetermined ones of the attractions. The transmitting of the notice of the premium charge period will include notifying the patrons for which attractions the premium will be charged or the credit given, as well as the dates, the time periods during any such dates, and any preferred seating positions on the respective attractions, for which the premium will be charged or the credit given.

The patron responds to the notice of the premium charge period, if so and as desired, through the Communications device and informs the control system computer for which attractions the patron will agree to pay the premium or receive the credit, as well as the dates, the time periods during any such dates, and any preferred seating positions on the respective attractions, for which any such premium will be charged or the credit given. Thereafter, the control system computer will charge a pre-established patron account for the premium to be paid by the patron, or issue a credit to the patron account, in response to the patron's accepting or declining, respectively, the notice of the premium charge period. The control computer will then inform the appropriate attraction queuing system computer of the patron's response to the notice of the premium charge period, the queuing system computer then placing the patron in the appropriate position in the queue line for the attraction during the premium charge period for the selected attraction, or will assign a place the patron in a second premium queue line for the selected attraction during the premium charge period for the selected attraction.

A third aspect of our invention provides a queue control system that enables the proprietors of the attraction or the event for which the patrons are in a queue line the option to reduce their respective waiting times in the queue by accelerating their progress through the queue upon the payment of a progress acceleration fee or premium. This is accomplished by transmitting an offer, through the LAN to those patrons with one of the communications devices, the offer of paying a progress acceleration fee which will entitle the patron(s) accepting the offer of the opportunity to be accelerated through the queue line for selected attractions, and of the amount of a progress acceleration premium for so doing. Should the patron choose to respond to the offer, again through their respective rental communications device, the control computer will charge the respective patron accounts the amount of the progress acceleration fee premium for those patrons that chose to accelerate their place in the queue line for any selected attractions.

The control computer of the system then informs the appropriate attraction queuing system computer of the patron's response to the offer of the progress acceleration fee, the queuing system computer then placing the patron in the appropriate position in the queue line for the attraction during the progress acceleration fee or premium charge time period for the selected attraction, or by assigning the patron a sequential position in a second or premium queue line for the selected attraction during the progress acceleration fee time period for the selected attraction. Toward this end, the queuing system computer may assign the patron a virtual place in either the single, or the second, queue line maintained during the progress acceleration premium fee period for the selected attraction.

It is to these objects, as well as to the other objects and features of the invention described herein, to which this invention is directed.

### BRIEF DESCRIPTION OF THE DRAWINGS

FIG. 1 is a schematic illustration of an attraction with at least one queue line illustrating a queuing control system for use therewith.

FIG. 2 is a schematic illustration of a multi-attraction venue illustrating a queuing control system for use therewith.

FIG. 3 is a flow chart of a manner in which a queuing control computer of the invention tracks a patron's time through the queue line of an attraction.

FIGS. 4A and B together are a flow chart of a queue control methodology practiced by the queuing control system of the invention.

FIG. 5 illustrates a second queue control methodology practiced by the queuing control system of the invention.

FIG. 6 illustrates a third queue control methodology practiced by the queuing control system of the invention.

### DETAILED DESCRIPTION

There are many places where it may be of great benefit to patrons to utilize a system of allocating queue positions in order to avoid physically waiting in a line. These include not only amusement or theme parks, but also airports, immigration and visa offices, museums, entertainment centers, and any other target events or attractions where the capacity at a given time is less than the number of patrons wishing to enjoy that facility, or the facility's throughput rate is less than the numbers of would-be patrons presenting themselves at the attraction.

Although the description of the several embodiments of the inventive queue control system and method are described with regard to the manner in which the system would be constructed and used within a theme park venue, it will be appreciated by those skilled in the art that any of the queue control systems described herein as well as the respective uses thereof, although described for use within an amusement park, can be used with any type of queue establishment and management system and method, and are not limited in use to amusement parks. Accordingly, the queue systems described herein may be applicable in innumerable situations of queue management, and are intended for use in any such situations, to include not only amusement or theme parks, but also airports, immigration and visa offices, museums, entertainment centers, and any other target events or attractions where the capacity at a given time is less than the number of patrons wishing to enjoy that facility, or the facility's throughput rate is less than the numbers of would-be patrons presenting themselves at the attraction. By describing only one of the possible applications herein, the described queue control system aims to limit repetition without detracting from the system's applicability to other types of venues and activities.

In the first embodiment of the invention, the queuing system logs each patron into their proper sequential position in a single queue for the specific attraction with which the queue is associated, which queue position is entirely dependent on the time at which the patron logs into the queue. Logging-in to the queue may be by accomplished by physically arriving at the tail end of the physical queue line, for example, and booking into the system, or may occur at a suitably equipped booking station located either at the attraction or elsewhere with respect thereto, which may for example be located away from the attraction itself. So constructed and used, the causes of disagreement between patrons physically present in the queue line, and those who are virtually present within the queue, will hopefully be minimized. Additionally, and as described below, the inventive queuing system may be further employed to inform the virtual patrons of their progress through the queue.

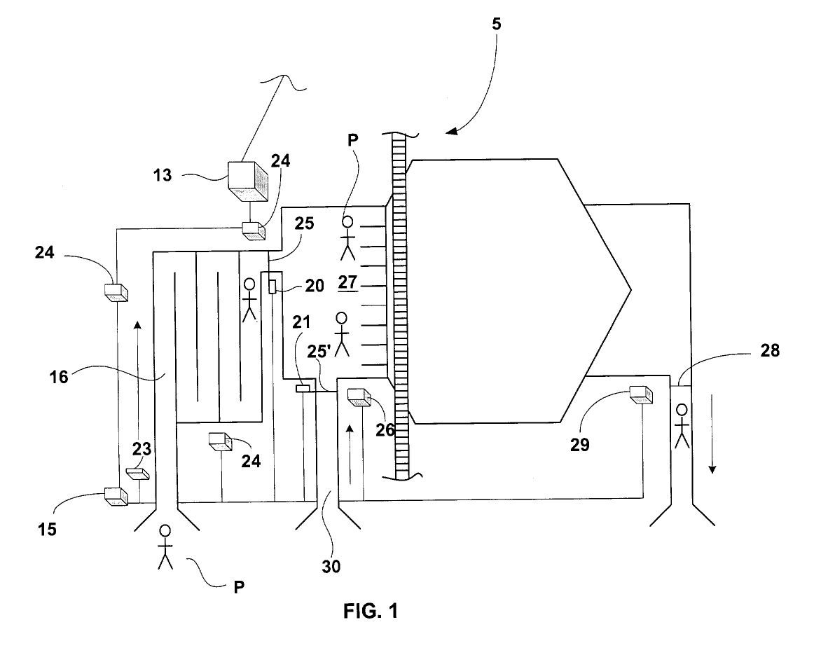

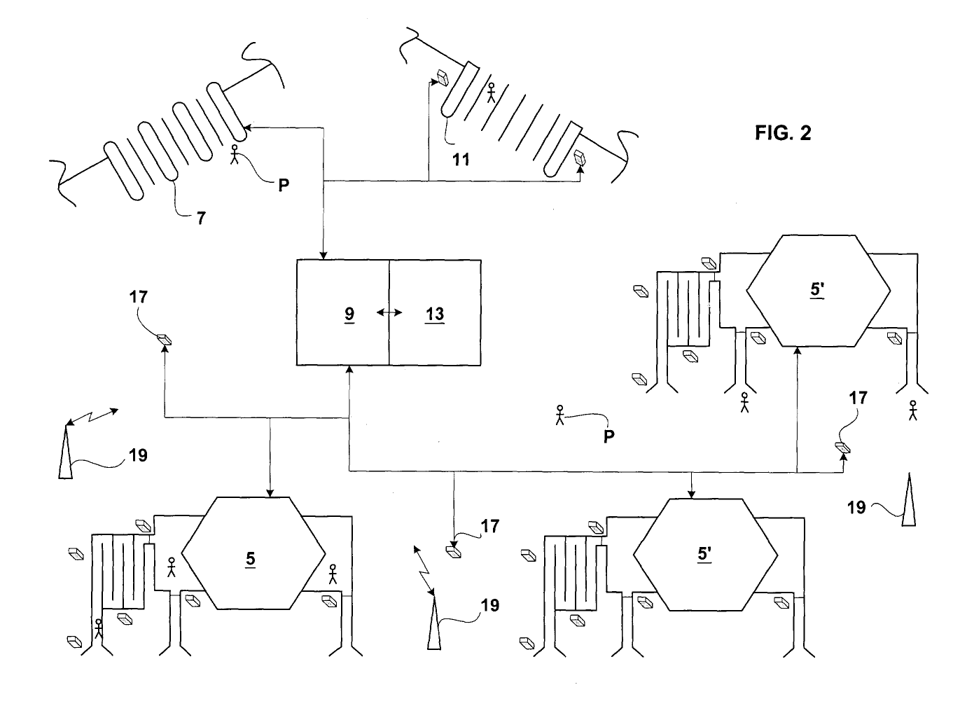

Referring now to the drawings, in which like reference characters indicate like parts throughout the several views, a first embodiment of the inventive queue system and queuing method is disclosed in FIGS. 1-4B. Referring now to FIG. 2, as known, theme parks typically comprise a single bounded site or venue covering a large ground area. Within that site there may be numbers of mechanical rides or other attractions 5′ giving various degrees of attraction and thrill, as well as natural attractions, restaurants, refreshment shops, gift shops, retail sales outlets, and additional attractions such as entertainment shows and contests of skill or ability. The theme park is typically completely surrounded by a fence (not illustrated) so that the public can enter the park only through one or more designated venue entry gates 7, where the basic entry fee is paid for such admission. Once admitted to the theme park the customer may attend any of the shops or attractions, in many cases without further payment, all as desired.

Because each attraction has a high capital cost and has room for only a limited number of people, the park proprietor's aim is to fill every customer space on each attraction on every cycle of every unit engaged in its operation. Therefore a queue line will form in a designated queuing line-up area, for example a gate house, once the customer has elected to become a patron of that attraction.

Upon admission through one of the theme park's entry gates 7, each customer or patron, denoted generically in the drawings by the reference character “P,” will be given a unique entry token, for use in personally or individually identifying the respective patrons as being in the appropriate queue. The token may comprise a printed token or ticket as such, for example, but may also comprise a virtual token by which any suitable means may be used for identifying and associating a specific person's entrance into the desire queue. These forms of identification may thus include, but are not limited to, a retinal scan, a finger print, and/or face recognition software.

Such tokens or means of guest identification will be unique to that patron and that patron's visit by having a unique identifier assigned thereto within the venue by a central admission or control computer 9, each of which is interchangeable for the purposes of this description, and may be disposable by the customer following completion of the visit and after departure from the park through an exit gate 11. The physical token, if one is used, may be formed of any suitable medium including, but not limited to a paper ticket or token, or a plastic card and the like.

The token will carry details of the date and time of the customer's admission to the park in an electronically legible form capable of being read by transmission and reception of electromagnetic energy and without specific presentation at a suitable reading or detection device, one or more of which may be located at suitable locations throughout the venue. It is anticipated, however, that suitable reading or detection devices will be also made available at the respective attractions for those patrons who wish to physically confirm their presence in the queue.

The respective physical tokens or guest identifiers for each patron will also carry a unique number to identify the patron or customer in possession of the token, and in addition to being prepared or configured in an electronic readable form, will also be printed in a human readable form so as to allow the customer to read it or show it to a venue official or to another customer if required. The unique number will be generated by the central admission and control computer system 9 which will take account of the times of admission for all customers entering through each theme park entry gate or gates. In allocating the unique identification numbers the control computer will give consecutive numbers to all members of a group or party gaining admission to the park together, as well as the size of the party which will be included in the data incorporated on the admission token. The control computer will pass this token data on to a queue control system computer, also referred to herein as a queuing system computer 13. Of note, the control computer may comprise the queuing system computer, or vice versa, and the control computer will be in communication with each attraction 5 within the park, as well as with the queuing system computer 13 (FIG. 1), or each queuing system computer, if provided, for each separate attraction, as illustrated schematically in FIG. 2

The customer is thus free to roam about the venue looking for attractions that catch their collective fancy. If the customer elects to join the queue for an attraction, then upon joining that queue the admission token or their guest identification will be read or detected automatically by a first fixed scanner 15 located or otherwise positioned at the entrance to the particular attraction. The first attraction scanner will report the details of the holder's entry into the queue for that attraction to the queuing system computer that will allocate the patron's place at the tail end of the queue line 16 for that attraction. The next successive patron P to join the queue line will be similarly scanned and placed at the tail end of the queue behind patrons who have logged in to the queue for that attraction earlier in time, thus extending the computer image oft the queue by that person.

After admission to the park some customers can elect to pay an additional charge to avoid physically waiting in the queue line for some or all of the attractions, i.e., they can have their place in the single queue line for the attraction virtually held for them. Having agreed to pay the premium, the patron will then obtain, in a manner akin to that described in U.S. patent application Ser. No. 09/068,701 filed in the United States Patent and Trademark Office on May 13, 1998, and as also disclosed in British Patent No. GB 2,307,324 B, the provisions of each of which are fully incorporated herein by this reference, a personal tracking and communications device (“PTCD”) which will be used when subsequently selecting an attraction. The patrons with a PTCD will use the device to log-in and become a patron for the desired attractions and to communicate with the control computer through any one of a number of PTCD interaction stations.

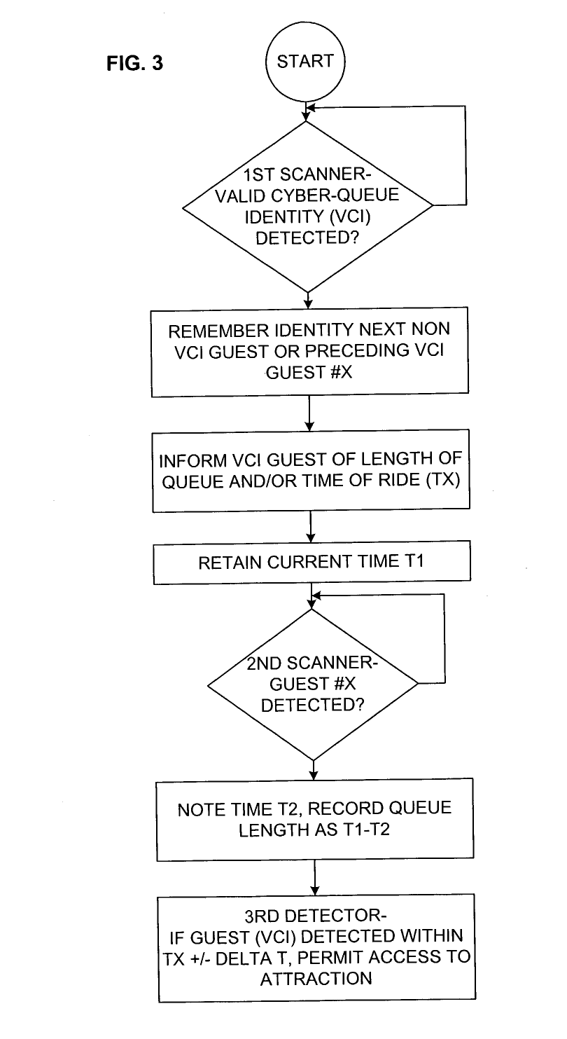

Once the queuing system computer has recorded the last patron to have been scanned by the first scanner 15 located at the entrance to the attraction, for example patron P1, the queuing system computer assigns the next sequential number to the next patron P2 to either be scanned or remotely logged into the system, regardless of whether that patron has a PTCD, as does P2 in this example. Patron P2's token and/or PTCD will have been scanned by the first scanner 15 when P2 becomes the next patron wirelessly logging, or otherwise being scanned, into the attraction queue line, as described above. The queuing system computer records the next (third) successive patron's position P3 as that succeeding P2, and so on, regardless of how P3 entered the queue. Similarly, the next patron to join the queue for the attraction will become P4, regardless of how they join the queue, whether by being scanned in or logging-in through their PTCD device, and so on. In all instances, therefore, only a single queue line for each specific attraction is established. See FIG. 3, which illustrates the process of how long a patron's wait in a queue line is determined.

Unlike P1, P3 and P4, however, patron P2 is now free to wander about the park and can obtain data about his or her progress in the queue from either their respective PTCD or from display terminals 17 (FIG. 2) positioned throughout the venue and linked to the control computer, as the queuing system computer also assigns P2 a virtual place in the queue line, and maintain P2's position in the queue line whether P2 is in the queue, or absent therefrom. In all such inquiries P2 will be given data about the position of P1 in the queue because the computer is reserving P2's place immediately after P1.

A patron who has hired or rented a PTCD may also use the PTCD to book a place in the queues for several successive attractions by either having the PTCD or their token detected and read by the first scanner 15 for additional ones of the attractions, or by remotely logging into the queuing system computer, through a wireless local area network (LAN) 19 within the venue, the LAN being in communication with the control computer 9, and thus with the respective queuing system computers 13 (FIG. 2) as well, provided that each such attraction has a token scanner at its exit gate. Each of such bookings will be processed in the sequence specified by the patron, and in accordance with the principles discussed below.

An alternate queue position allocation system can be provided to give a high degree of accuracy in allocating equitable positions in the virtual queue if the scanners along the real queue become inactive for any reason. This can be effected if a suitable counting device or devices are installed at the point of entry into the boarding area, for example a turnstile 20, and a second turnstile 21, as described in greater detail, below. Using such counting devices, the control computer, or the queuing system computer, is programmed to total all of the patrons boarding each cycle of the attraction, and then deducts from that total the number of patrons who have entered the attraction queue line through the use of a PTCD, thus yielding the number of patrons who have entered from the real queue. The resultant figures can then be used to calculate equitable ratios between physical patrons and virtual patrons in the queue line through a suitable algorithm that also takes account of the cycle time of the attraction, the number of places available in each cycle, and the total demand for that attraction. The determination of the actual algorithm is well within the knowledge of those skilled in the art, and thus is not described in greater detail herein.

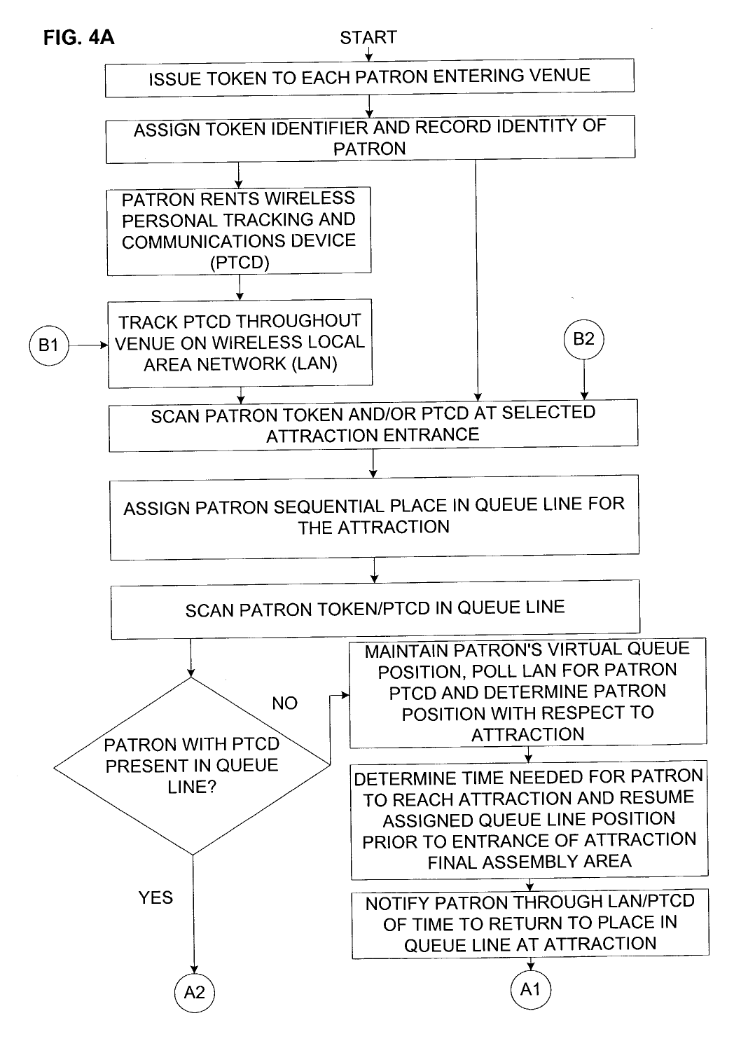

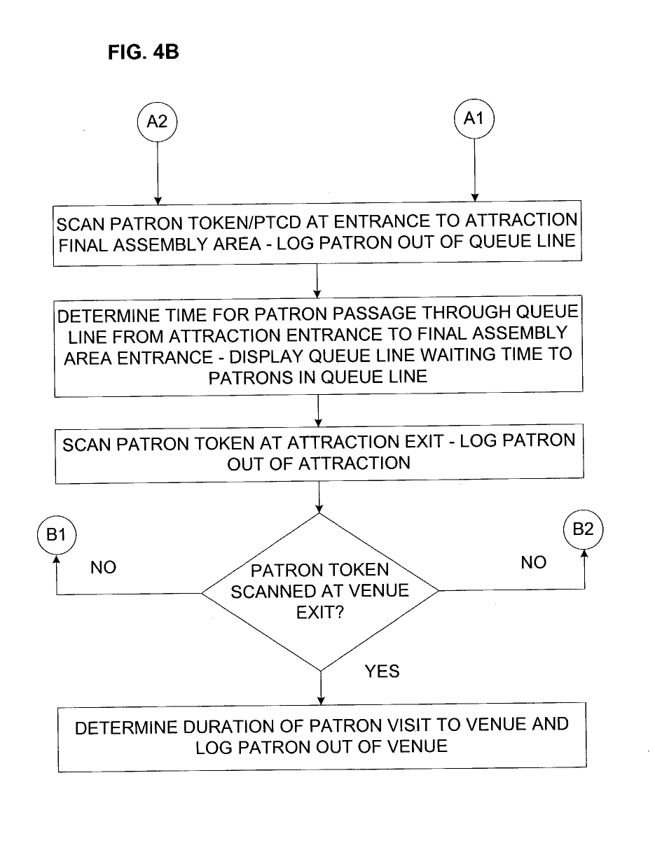

For those patrons who have paid to utilize a PTCD, their PTCD device will be tracked throughout the park by the control computer in a manner akin to that described in U.S. patent application Ser. No. 09/068,701 filed in the United States Patent and Trademark Office on May 13, 1998, and as also disclosed in British Patent No. GB 2,307,324 B, as referenced above and incorporated herein. The control computer, knowing the patron's exact location in the venue, will estimate the time that the patron will require to reach the next booked attraction from that location. Accordingly, the computer will take this time period into account when advising a PTCD user of the need for their return to the attraction in which they are queued by giving the PTCD user a suitable lead time to return to the attraction, as illustrated in FIGS. 4A and B.

As known, queued patrons waiting for an event to happen frequently complain of a lack of information. To alleviate such complaints a display screen 23 may be placed, if so desired, near the first scanner 15 at the entry point to the attraction where a patron joins the physical queue for the attraction or event so that the patron can immediately ascertain their status in the queue. Such displayed information may include, but is not limited to, the display of the patron's token number or guest identification code; the patron's sequential number in the queue; the number of mechanical (ride) cycles that the attraction must perform before that patron can gain access to the attraction, where relevant; the estimated time at which that number of cycles will have been completed; the token number of the patron immediately in front of the patron in the queue line, whether or not physically present; the token number of the patron immediately behind the patron in the queue line, whether or not physically present; park notices; advertisements and advance notices; and any other information which may be relevant to the patron, the type of attraction, the theme park's operations and so on.

It is anticipated that additional token/PTCD scanners 24 and information display stations (not illustrated) may be provided along the length of the physical queue line, each of which is in communication with the queuing computer system, so as to enable patrons to review their current status. If personal privacy were specified by the venue management, such stations would preferably ask the patron to insert their token into a token reader, or pass the token thereby, in order to obtain the updated information. If the proprietor of the attraction wished to charge extra for providing the information, the display could be coin or credit card operated. The information displayed would include all or any of that information given at the entry point and additionally report on whether there is either a delay or an improvement in the estimated admission time to the attraction, whether any patrons have left the queue line ahead of the patron (the queuing system computer will not permit a patron to be inserted into the preceding queue position), and whether as a consequence the token number of the patron immediately in front of the patron has changed.

A patron that has elected to virtually hold their position in the queue by the use of a PTCD will be constantly updated by their PTCD, via the LAN and the control computer, of their place in the queue, and of the estimated time to ride or otherwise enter the attraction for which they have logged-in. The PTCD will relay any of the foregoing information if it is additional to the information previously given to the patron by the PTCD when it is first used by the patron to reserve their virtual place in the queue line.

With regard to the admission procedures used with the queuing system, at pre-determined times before the commencement of the next cycle of the attraction, the queuing system computer for that attraction will open the queue and the patrons holding a PTCD that is eligible for that cycle will be called to the attraction, and will also be notified of a closing time for their admission to that attraction cycle (FIGS. 4A-B). The notice given to a patron holding an eligible PTCD will be given with a sufficient advance time, as determined by the computer, which the queuing system regards as needed to allow that patron, or group of patrons, to reach the attraction before their closing time for that cycle, even if it is necessary for such notice to be given in advance of the actual time they will be permitted to enter the attraction, i.e., how long will it take for the patron(s) to arrive at the attraction. There will be an access control station or gate 25 at the attraction for those who are virtually present within the queue. The access control station may comprise one or more entry gates, each gate being equipped with a scanner 26 capable of reading the patron's token and of also reading a patron's PTCD, the scanner being in communication with the queuing system computer. If the patron has both a token and an eligible PTCD the gate will open and admit the patron to the final assembly, i.e., the boarding, area 27 for the attraction. If the patron is physically present in the queue and has a token that is sequentially qualified for that cycle, then he or she will be allowed to proceed to the final assembly area. Each gate may be additionally equipped with a display (not illustrated) visible to nearby patrons showing the total number of places available in that cycle, the last qualifying sequential number for that cycle, the sequential number of that patron in the process of admission to the attraction, and any other information which may be of help to the remaining patrons in the queue and/or the operators supervising the attraction.

The exit from the queue line will be accomplished by passing through the gateway 25 into the final boarding area which, as known, will comprise one or more boarding stalls that are aligned with the multiple entrances of the vehicles or carriers forming part of the attraction. If a patron arrives at the admission control with a non-qualifying token or a non-eligible PTCD, that patron will be reminded of their correct sequential number or position in the queue, and requested to return to their proper place in the queue. Such advice may be given by a human operator or by a display not generally legible to others in the queue.

A patron holding a PTCD that arrives after the notified closing time for any cycle may not be admitted to that cycle and will be placed at the head of the next succeeding cycle. That patron's original reservation will be given to the patron holding the next sequential reservation in the physical queue, thus effectively exchanging their sequential positions. A PTCD holder that has not checked in at the admission control station before the start of the cycle for which they held a reservation may be automatically re-entered in the tail end of the queue, dependent upon their time of arrival and the venue management's discretion.

Because each token contains data unique to an individual patron, the queuing system computer will be aware of the numbers of patrons actually entering each attraction. By installing an exit gate 28 provided with a token scanner or guest identification device 29 thereat, the queuing system computer can check that every patron, each patron in a party of patrons having their own token, has left each cycle of the attraction, and may also be programmed to sound an alert in the event of a mismatch thus allowing a search to be made for any missing patron or patrons within the attraction. Such a search could be of importance in preventing stowaways in the more dangerous attractions. The process could also be applied to the exits 11 from the theme park so as to allow security staff to be aware if any customers remain in the park when it closes at night. The data arising from these security assessments will also be of great value to the venue's management in future operational planning.

If the exit gate 28 and exit scanner 29, as described above, are in use at the exit of the first attraction booked by a patron that has used the PTCD to be virtually present in the queue, the queuing system can be extended to immediately allow that patron to subsequently elect to reserve a similar sequential place in the queue for an alternate or second attraction at which they will subsequently log-in while waiting for their turn at the first attraction to which they are currently logged-in.

Any such subsequent reservation(s) will be managed by the queuing system computer for any such additional attraction in the following manner. The patron will be positioned at the tail end of the queue for the subsequent attraction, and will retain that tail end position at least until they have been admitted into the final assembly area of the first booked attraction. The queuing system computer will thereafter admit the patron into the moving queue for the subsequent attraction unless that queue is so short that the patron would be unable to travel from the first attraction to the subsequent attraction in the estimated time available. In this event, the queuing system computer will admit the patron to the moving queue after a predetermined time has elapsed following the patron's admission to the first attraction. If the patron has not been registered as passing through the exit gate 28 of the first attraction within the time estimated by the queuing system computer, then the queuing system computer will hold the patron's place static in the queue line for the second attraction, and allow the remainder of the patrons in the queue to bypass the reserved patron's position in the queue on a one-by-one basis until the reserved patron is recorded as having exited the first attraction. Thereafter the patron's place in the second queue line will commence moving forward as the queue moves forward. The patron's progress in the subsequent queue will be advised to them by their respective PTCD. The patrons in the queue for the subsequent attraction cannot be delayed by a delay to a patron holding a virtual place in the queue, although they may be accelerated in line by the failure or inability of the PTCD user to arrive at the attraction in time. Once a patron has been fully admitted into the sequential queue for the subsequent attraction, that patron's admission to that attraction will be subject to the principles discussed, above.

Thus the patron who has rented a PTCD and used either their PTCD or the respective scanners 15 of additional attractions to book (reserve) places in the queues for those attractions can move on to the next attraction without the need to rush and join the line therefore, provided that each attraction has a scanner at its exit gate, as discussed above. Each of such bookings will be processed in the sequence specified by the patron, and in accordance with the principles set out above hereinabove.

An alternate queue position allocation system can be provided to give a high degree of accuracy in allocating equitable positions in the virtual side of the queue line if the token scanners along the physical queue become inactive for any reason. This can be effected if a suitable counting or guest identification device or devices, namely the turnstiles 20 and 21, respectively, are installed at the point of entry into the boarding area, as described above. Using such counting devices, each of which is in communication with the queuing system computer, the queuing system computer totals all of the patrons boarding each cycle of the attraction and then deducts from that total the number of patrons who have entered the final assembly area under the authority of a PTCD, for example through the turnstile 21, thus yielding the number of patrons who have entered from the real or physical side of the queue. The resultant figures can then be used to calculate equitable ratios between patrons physically present in the queue, and those who are virtually present in the queue through an algorithm that also takes into account the cycle time of the attraction, the number of places available in each cycle, and the total demand for that attraction.

In a second aspect of the system, a queue control system is provided which enables the proprietors of the attraction or the event for which the patrons are in a queue line to balance the length of the respective queue lines for any and all associated attractions or events across periods of high and low demand, as the physical queuing of the patrons tends to reduce the earning capacity of attractions or events surrounding the target attraction as the patrons for these attractions are standing in line at the target attraction, which thus restricts the ability of the patrons to spend money or take part in other nearby attractions or events such as restaurants, shops, and other rides in a theme park.

There are several situations where such a system could be applied. The first of these arises in the situation where a particular attraction has forecast periods of very high demand, either at certain times of the day, or on certain days in any season. The proprietor may wish to improve the return on capital by charging a premium rate to patrons both physically or virtually present within the queue who wish to participate in the attraction at the time(s) of such a peak demand. Conversely the proprietor may consider it advantageous to charge a negative premium, i.e., provide a discount or credit to a pre-established patron account, for example where a PTCD user has obtained the device by using a credit card number to bill against or to receive a credit, during periods of slack demand in order to attract more customers to the attraction or event and thus increase the probability of those customers spending monies on adjacent attractions. Yet another possibility of charging a premium for a particular attraction arises from the preferences of patrons for particular seats on particular attractions. If such a preference exists, then it can be charged for at a premium rate in similar fashion to the charges in theatres, cinemas and other places of entertainment.

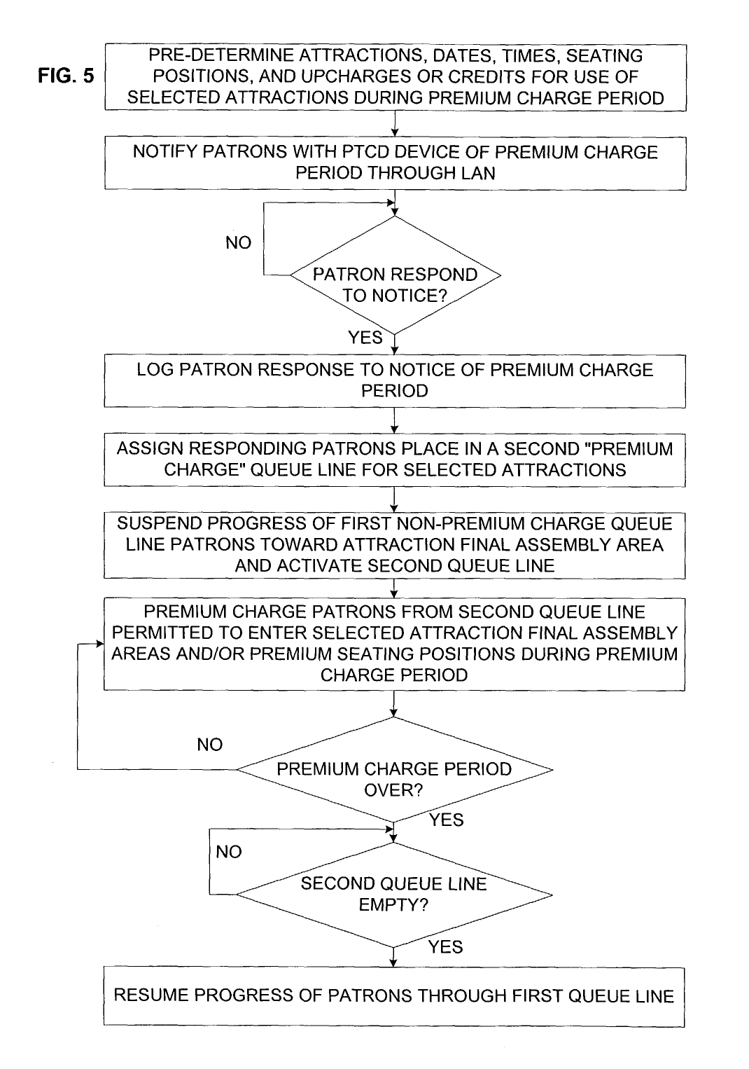

Referring now to FIG. 5, which schematically illustrates this process, the details of the premium, whether positive and/or negative, charge periods, and the charges applicable thereto will be predetermined by the venue's management and loaded into the control computer and/or queuing system computer before the start of the day's business. The premium charge periods and the charges may also be displayed to the customers of the park as they enter the attraction, or at the park entrance where patrons obtain their entry tokens. Those park customers who opt to become patrons of an attraction by visiting a scanner 15 to pre-book attractions through the use of a PTCD will be charged, or credited on their respective patron account where appropriate, with any appropriate premiums in addition to the normal rental of the PTCD charged to their account as they book at the scanner/entry station 15 and progress from there onwards to virtually join one or more attraction queues and to be processed as described above. If, upon leaving the attraction, the management considers that any premium paid by the customer should be refunded, such refund will be effected through the PTCD as a credit to the patron's patron account.

Those customers who proceed directly to an attraction, as discussed above, will be given additional information by the display at the start of the queue for that attraction. That additional information will notify them of the start and end of the next premium time periods; whether or not an immediate joining of the queue will enable that patron's admission to the attraction to take place before the start of the premium period, and in the case where the patron has to continue waiting until after the end of the premium period, what their total waiting time in the queue will be; the price of the premium; and whether payment of the premium, apart from the PTCD rental fee, will give the patron an advantage in enabling them to remain in the real queue and access the attraction before expiry of the premium period.

When a patron physically present in the queue has paid the premium for an attraction, that patron will take their respective physical place in the premium queue, which may comprise a second separate queue line 30 (FIG. 1). For the duration of any premium charge period for a particular attraction, the premium queue will contain both real (physical) and virtual queue members, and will be the only queue for that attraction to be progressed by the queuing system computer unless that computer is specifically tasked with alternate instructions provided by the venue management, for example, the premium charge queue line is empty. During any premium charge period the queuing system computer will process the premium queue in the same manner as described above for the first embodiment of the system while continuing to accept and sequentially allocate the registrations of patrons for subsequent non-premium periods.

Upon the cessation of a premium charge period the queuing system computer will recommence the advancement of the standard queue as described above for the first embodiment of the system. When a patron has paid a premium for an attraction they may be given a supplementary token or identification code to identify their eligibility for admission during the premium period, or alternately their original token may be exchanged for another similar token which carries with it all of the original token information plus the data concerning the premium registration. As compared with the first embodiment of the queuing system, the second embodiment of the queuing system will require the use of a PTCD device, the addition of a payment, and may also require a separate token issue facility at the tail end of the queue. The second embodiment of the queuing system may also necessitate the use of an additional token scanner 26 positioned at an access control gate 25′ to the final assembly area of the attraction to enable the supplementary or revised token to be read thereat.

At some attractions customers show strong preferences for particular locations so that it becomes necessary for the venue management to apply some form of regulation of the boarding process, for example the front and rear seat rows of a roller coaster. Where such a preference exists it may be possible for the venue management to charge a premium for the preferred positions, or to have a scale of supplements to match the perceived preferences. Where any such separation in the attraction queue line is installed it will be necessary to arrange customers at the boarding point for the differing classes or positions on the attraction so that they are pre-sorted into separate lines after having properly gained admission to the boarding area through the appropriate access control or entry gates, as is commonly done.

Where the venue management implements the second embodiment of the system, the first embodiment of the system as described above will be adapted by setting the queuing system computer to establish separate queue lines (not illustrated) for each class of accommodation. Each of those queue or class lines may contain both physical and virtual patrons in the queue, as described above; or if the management so decides, one or more seat classes might be made available only to virtual patrons holding a PTCD in which case the first embodiment of the queuing system would continue to operate as discussed above.

The premium charges described above can also be combined with the position or class of the seats on the attraction proposals as also discussed above so that, if required by the venue management, any or all of the seat classes can be charged at premium rates at the appropriate or desired times. Moreover, the different seat classes can differ from each other with respect to their premium rates and premium times once the appropriate instructions have been given to the central control computer. Where a proliferation of premium times and supplementary location rates exist, the displays to customers can be arranged to advise customers of their options.

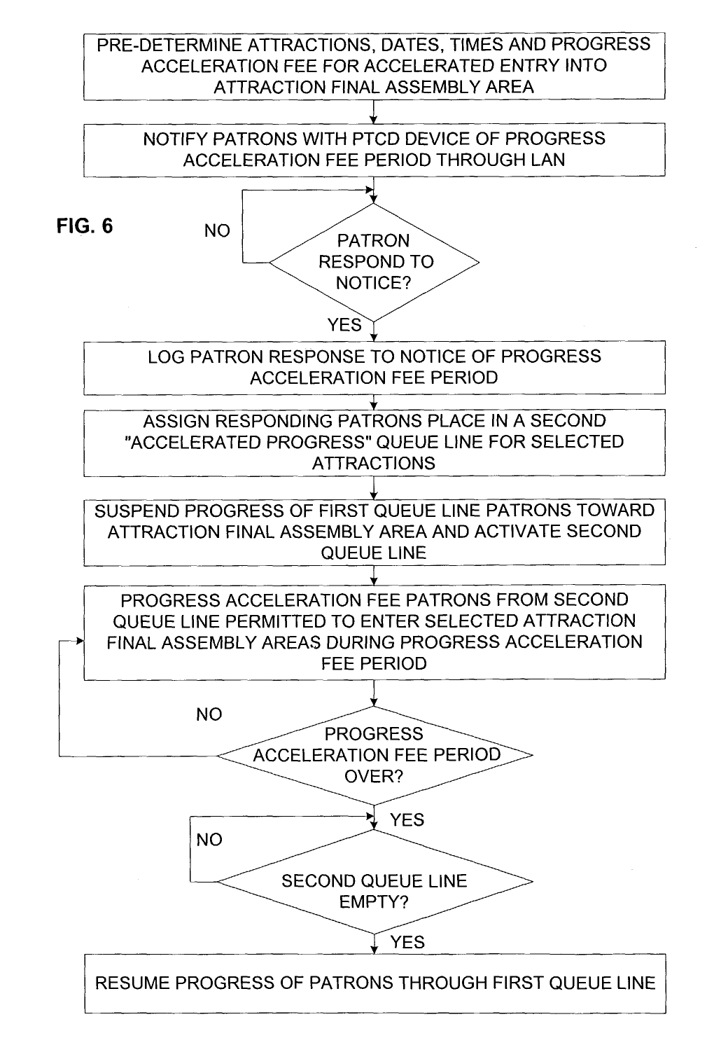

A third embodiment of the invention provides yet another queue control system and method that enables the proprietors of the attraction or the event for which the patrons are in a queue line the option to reduce their respective waiting times in the queue by accelerating their progress through the queue upon the payment of a progress acceleration fee or premium. This embodiment of the system, illustrated in FIG. 6, permits a prospective patron of an attraction to once again rent a PTCD and then pay a progress acceleration fee (“PAF”) to become a patron with accelerated progress toward the head of the queue when joining that queue at the entry station for that attraction. The maximum PAF payable would enable the queuing system computer to estimate the time delay required for the patron to reach the attraction from the patron's present location to the desired attraction's final assembly area, and then the virtual progress of the patron along the queue to the head of that queue to be in position for the next cycle of the attraction. A descending PAF scale could be provided for each subsequent cycle of the attraction so as to give the patron the option of paying a lesser PAF for a preferred position farther back in the queue.

In implementing the third embodiment of the system, the central control computer will pre-allocate a predetermined number of places in each cycle of the attraction in anticipation of those spaces being occupied by accelerated patrons. If any of those spaces have not been reserved by a patron by the time that all of the other virtual and physical or patrons in the queue for the attraction have passed through the admission control gates into the final assembly area, the queuing system computer will allow admission of the appropriate number of physical and virtual patrons in the first queue line, and in their proper numerical order, i.e., their allocated queue sequence, to pass into the final assembly area of the attraction. This supplementary admission will continue until all places in that cycle are allocated, or until the cycle is scheduled to close for boarding.

In applying such supplementary admissions for patrons of the virtual queue, the queuing system computer would ensure that any such patron who had not then arrived early at the admission control point would not subsequently be treated as a late arrival solely as a direct consequence of any advancement of the virtual queue. The queuing system computer would automatically allocate a place in the first of the succeeding cycles to a PAF paying patron arriving at the admission control point after its closure for that patron's allocated cycle. If a PAF patron were to arrive for the second or any later succeeding cycles of the attraction, that patron might be allocated a place at the discretion of the venue management.

The PAF embodiment of the queuing system may be incorporated into the second, premium charge period, embodiment of the system, as discussed above, as well. This queuing method may further include the step of offering the patrons a progressive acceleration in the queue line of selected ones of the attractions in exchange for the payment of a greater one of a series of progressive progress acceleration premium charges for each selected one of the attractions.

Although several embodiments of the invention have been disclosed in the foregoing specification, it is understood by those skilled in the art that many modifications and other embodiments in the invention will come to mind to which the invention pertains, having the benefit of the teaching presented in the foregoing description and the associated drawings. It is thus understood that the invention is not limited to the specific embodiments disclosed hereinabove, and that many modifications and other embodiments are intended to be included within the scope of the invention. Moreover, although specific terms are employed herein, they are used only in a generic and descriptive sense, and not for the purposes of limiting the scope of the described invention.

We claim:

1. A queuing system for use in controlling the movement of a plurality of patrons through the queue line of an attraction, the attraction being located within a multi-attraction venue having a venue entrance and a venue exit, each respective attraction within the venue having an attraction entrance, a final assembly area in which patrons gather immediately before boarding the attraction, and an attraction exit, said system comprising:
a token for each patron, each said token having a unique identifier associated therewith;
a first scanner at the entrance to the attraction, said first scanner being constructed and arranged to detect and read the token of each patron passing through the entrance to the attraction;
a second scanner at the final assembly area of the attraction, said second scanner being constructed and arranged to detect and read the token of each patron passing into the final assembly area of the attraction;
a third scanner at the exit from the attraction, said third scanner being constructed and arranged to detect and read the token of each patron passing from the attraction; and
a queuing system computer in communication with each of said scanners.

2. The system of claim 1, wherein the queuing system computer assigns each successive patron of the attraction a sequential place in a single queue line for the attraction in response to the scanning of said tokens by said first scanner.

3. The system of claim 1, the queuing system computer being programmed to track the progress of each patron through the queue line of the attraction, and to calculate the time required for the patron to pass from the entrance of the attraction through the queue and into the final assembly area of the attraction.

4. The system of claim 1, further comprising a control computer in communication with the queuing system computer.

5. The system of claim 4, the control computer being in communication with each respective attraction within the venue.

6. The system of claim 4, wherein the control computer assigns the identifier for each respective patron's token in the venue.

7. The system of claim 6, said identifier comprising a unique identification number for each patron, assigned sequentially for each successive patron entering the venue.

8. The system of claim 6, wherein the control computer forwards the identifier associated with each respective patron to the queuing system computer once the patron's token is scanned by said first scanner.

9. The system of claim 4, wherein each patron receives a token at the venue entrance.

10. The system of claim 9, further comprising at least one exit scanner positioned at the venue exit and in communication with the control computer, said at least one exit scanner being constructed and arranged to detect and read the token of each patron exiting the venue.

11. The system of claim 10, wherein the control computer is programmed to determine if the patrons have exited the venue, and to track each respective patron's time from entry of the venue to the time they exit the venue.

12. The system of claim 1, further comprising a queuing system computer for each respective attraction within the venue.

13. The system of claim 1, wherein the queuing system computer comprises at least a portion of a control computer, the control computer being in communication with each respective attraction within the venue.

14. The system of claim 1, wherein each patron receives a token at the entrance to the venue.

15. The system of claim 1, wherein each token is constructed and arranged to emit a unique electromagnetic identification signal.

16. The system of claim 15, wherein each of said scanners is constructed and arranged to detect and read the respective electromagnetic identification signal from each said token.

17. The system of claim 1, further comprising at least one fourth scanner positioned with respect to the attraction queue line, intermediate said first and said second scanners, respectively, said at least fourth scanner being in communication with the queuing system computer and constructed and arranged to detect and read the token of each patron passing thereby.

18. The system of claim 1, further comprising a video display at the attraction, the video display being in communication with the queuing system computer and adapted to display information to the patrons of the attraction.

19. The system of claim 1, further comprising a wireless local area network within the venue, the local area network being in communication with a control computer, the control computer being in communication with the queuing system computer.

20. The system of claim 19, further comprising at least one wireless personal tracking and communications device for use by at least one of the respective patrons of the venue, said at least one communications device being constructed and arranged to be in communication with the control computer through the local area network, each said communications device being constructed and arranged to emit a signal adapted to be detected and read by each of said scanners and for being received by the local area network throughout the venue.

21. The system of claim 20, wherein the queuing system computer assigns the at least one patron using one of said communications devices with a virtual place in a single queue line for that attraction when that patron's communications device is scanned at the entrance to the attraction.

22. The system of claim 21, wherein the queuing system computer tracks the progress of the at least one patron using one of said communications devices through the queue line whether the patron is present in the queue or located elsewhere within the venue, and if absent from the queue, holds the patron's virtual place in the queue line for the attraction.

23. The system of claim 21, wherein the queuing system computer notifies the control computer, and the control computer notifies the at least one patron through the local area network, of the patron's estimated time to re-enter the queue line in order to enter the final assembly area of the attraction.

24. The system of claim 21, wherein the control computer polls the local area network for the at least one patron's communications device, determines the location of the patron within the venue with respect to the attraction, and forwards this information to the queuing system computer, wherein the queuing system computer then determines the time needed for the patron to return to the attraction and their place in the queue line and notifies the patron, through the control computer and the local area network, in advance of the time the patron needs to re-enter the queue line in order to enter the final assembly area for the attraction.

25. The system of claim 21, said at least one communications device comprising a two-way wireless communications device, and wherein the at least one patron may selectively access the queuing system computer through said communications device in order to determine the patron's status in the attraction queue line.

26. The system of claim 25, wherein said at least one communications device is constructed and arranged to access a second queuing system computer, though the control computer, controlling at least a second one of the attractions within the venue, and to make a reservation request in the queue line for the at least second attraction.

27. The system of claim 26, wherein the patron's reservation request for the at least second attraction is filled and the patron placed in the queue line therefor once the patron passes through the second scanner positioned at the final assembly area of the first attraction.

28. The system of claim 1, further comprising a first turnstile positioned at the entrance to the final assembly area of the attraction, said first turnstile being in communication with said queuing system computer.

29. The system of claim 1, further comprising a second turnstile positioned at the exit of the attraction, said second turnstile being in communication with said queuing system computer.

30. A queuing method for use in controlling the movement of a plurality of patrons through the queue line of an attraction, the attraction being located within a multi-attraction venue having a venue entrance and a venue exit, each respective attraction within the venue having an attraction entrance, a final assembly area in which patrons gather immediately before boarding the attraction, and an attraction exit, said method comprising the steps of:
issuing a token to each patron entering the venue;
assigning a unique identifier to each said token;
scanning the patron's token at a first scanner positioned at the entrance to the attraction;
scanning the patron's token at a second scanner positioned at the final assembly area of the attraction;
scanning the patron's token at a third scanner positioned at the exit of the attraction; and
forwarding the scanned information from each said scanner to a queuing system computer in communication with each of said scanners.

31. The method of claim 30, the queuing system computer assigning each successive patron of the attraction a sequential place in a single queue line for the attraction.

32. The method of claim 30, the queuing system computer tracking the progress of each patron through the queue line of the attraction, and calculating the time required for the patrons to pass from the entrance of the attraction through the queue and into the final assembly area of the attraction.

33. The method of claim 30, the step of assigning a unique identifier to each of said tokens being performed by a control computer in communication with the queuing system computer.

34. The method of claim 33, further comprising the control computer sequentially assigning a unique identification number for each successive token issued to each of the patrons as they enter the venue.

35. The method of claim 33, the control computer forwarding the identifier for each scanned token to the queuing system computer once the patron's token has been scanned by said first scanner.

36. The method of claim 33, the queuing system computer comprising at least a portion of the control computer.

37. The method of claim 30, further comprising the step of scanning the patron's token at an exit scanner positioned at the venue exit, said exit scanner being in communication with a control computer.

38. The method of claim 37, the control computer determining if the respective patrons have exited the venue, and tracking each respective patron's time from entry of the venue to the time they exit the venue.

39. The method of claim 30, further comprising the step of scanning the patron's token with at least a fourth scanner positioned with respect to the attraction queue line, said at least fourth scanner being in communication with the queuing system computer.

40. The method of claim 30, further comprising displaying, on a video display in communication with the queuing system computer and positioned at the attraction, the status of the patron's position in the queue.

41. The method of claim 40, the step of displaying the status of the patron's position in the queue further comprising the step of displaying at least one of the patron's token identifier, sequential number in the queue line, number of attraction cycles before entry to the final assembly area, estimated time in which the number of attraction cycles will be performed, the token identifier of the patrons immediately ahead of and behind the respective patron, advertisements, venue notices, and venue information and policies.

42. The method of claim 30, further comprising the step of selectively providing to at least one of the patrons a wireless personal tracking and communications device for use within the venue, said communications device being constructed and arranged to be in communication with a control computer through a local area network, the control computer being in communication with the queuing system computer, each said communications device emitting a signal adapted to be detected and read by each of said scanners and for being received by the local area network.

43. The method of claim 42, the queuing system computer assigning a virtual place in a single queue line for the attraction to each patron using one of said communications devices once that patron's communications device is scanned by said first scanner.

44. The method of claim 42, the queuing system computer tracking the progress of each patron with one of said communications devices through the queue line whether the patron is present in the queue line or located elsewhere within the venue, and if absent from the queue, holding a virtual place in a single queue line for the attraction for the patron.

45. The method of claim 42, the queuing system computer notifying the control computer, and the control computer notifying the at least one patron through the local area network, of the patron's estimated time to board the attraction.

46. The method of claim 42, the control computer polling the local area network for the patron's communications device, determining the location of the patron within the venue with respect to the attraction, and forwarding this information to the queuing system computer, the queuing system computer then determining the time needed for the patron to return to the attraction and their place in the queue line and then notifying the patron, through the control computer and the local area network, in advance of the time the patron needs to re-enter the queue line in order to be present to enter the final assembly area of the attraction.

47. The method of claim 42, said at least one communications device comprising a two-way wireless communications device, further comprising the step of the at least one patron accessing the queuing system computer through said communications device to determine their status in the attraction queue line.

48. The method of claim 42, further comprising the step of using said communications device to access the queuing system computer controlling at least a second one of the attractions within the venue, and making a reservation request in the queue line therefor.

49. The method of claim 48, further comprising the steps of filling the patron's reservation request for the at least second attraction and assigning the patron a sequential place in the queue line therefor once the patron passes through the second scanner positioned at the final assembly area of the first attraction.

50. The method of claim 42, further comprising the step of transmitting through the local area network to those patrons in possession of one of said communications devices a notice of a premium charge period during which a premium will be charged, or a credit given, to a patron for their use of predetermined ones of the attractions.

51. The method of claim 50, the step of transmitting the notice of the premium charge period further comprising the steps of notifying patrons for which attractions the premium will be charged or the credit given, as well as the dates, the time periods during any such dates, and any preferred seating positions on the respective attractions, for which the premium will be charged or the credit given.

52. The method of claim 50, further comprising the step of the patron responding to the notice of the premium charge period through the communications device and informing the control system computer for which attractions the patron will agree to pay the premium or receive the credit, as well as the dates, the time periods during any such dates, and any preferred seating positions on the respective attractions, for which any such premium will be charged or the credit given.

53. The method of claim 52, further comprising the step of the control system computer charging a pre-established patron account for the premium to be paid by the patron, or issuing a credit to the patron account, in response to the patron's accepting or declining, respectively, the notice of the premium charge period.

54. The method of claim 52, further comprising the step of the control computer informing the appropriate attraction queuing system computer of the patron's response to the notice of the premium charge period, the queuing system computer then placing the patron in the appropriate position in the queue line for the attraction during the premium charge period for the selected attraction.

55. The method of claim 52, further comprising the step of the control computer informing the appropriate attraction queuing system computer of the patron's acceptance of the notice of the premium charge period, the queuing system computer then placing the patron in a second premium queue line for the selected attraction during the premium charge period for the selected attraction.

56. The method of claims 54 and 55, further comprising the step of the queuing system computer assigning the patron a virtual place in the queue line during the premium charge period for the selected attraction.

57. The method of claim 42, further comprising the step of transmitting an offer, through the local area network to the communications devices, of a queue line acceleration time period during which the patrons may be accelerated through the queue line for selected attractions, and of the amount of a progress acceleration premium for so doing.

58. The method of claim 57, further comprising the step of the patron responding to the offer through the communications device, and the control computer charging a pre-established patron account the progress acceleration premium for those patrons that chose to accelerate their place in the queue line for any selected attractions.

59. The method of claim 58, further comprising the step of the control computer informing the appropriate attraction queuing system computer of the patron's response to the offer of the progress acceleration premium charge time period, the queuing system computer then placing the patron in the appropriate position in the queue line for the attraction during the progress acceleration premium charge time period for the selected attraction.

60. The method of claim 58, further comprising the step of the control computer informing the appropriate attraction queuing system computer of the patron's acceptance of the offer of the progress acceleration premium charge time period, the queuing system computer then placing the patron in a second premium queue line for the selected attraction during the progress acceleration premium charge time period for the selected attraction.

61. The method of claims 59 and 60, further comprising the step of the queuing system computer assigning the patron a virtual place in the queue line during the progress acceleration premium charge time period for the selected attraction.

62. The method of claim 57, further comprising the step of offering the patrons a progressive acceleration in the queue line of selected ones of the attractions in exchange for the payment of a greater one of a series of progressive progress acceleration premium charges for each selected one of the attractions.

63. A queuing system for use in controlling the movement of a plurality of patrons through the queue line of an attraction, the attraction having an attraction entrance, a final assembly area in which patrons gather immediately before boarding the attraction, and an attraction exit, said system comprising:
a token for each patron, each said token having a unique identifier assigned thereto;
a first scanner at the entrance to the attraction, said first scanner being constructed and arranged to detect and read the token of each patron passing through the entrance to the attraction;
a second scanner at the final assembly area of the attraction, said second scanner being constructed and arranged to detect and read the token of each patron passing into the final assembly area of the attraction;
a third scanner at the exit from the attraction, said third scanner being constructed and arranged to detect and read the token of each patron passing from the attraction; and
a queuing system computer in communication with each of said scanners, wherein the queuing system computer assigns each successive patron of the attraction a sequential place in a single queue line therefor in response to the scanning of said tokens by said first scanner.

64. The system of claim 63, further comprising at least one wireless personal tracking and communications device for use by at least one of the respective patrons of the attraction, said at least one communications device being constructed and arranged to be in communication with the queuing system computer through a local area network also in communication with the queuing system computer, each said communications device being constructed and arranged to emit a signal adapted to be detected and read by each of said scanners and the local area network.

65. The system of claim 64, wherein the queuing system computer assigns the at least one patron using one of said communications devices with a virtual place in the queue line for that attraction when that patron's communications device is scanned at the entrance to the attraction.

66. The system of claim 65, wherein the queuing system computer tracks the progress of the at least one patron using one of said communications devices through the queue line whether the patron is present in or absent from the queue line, and if absent from the queue, holds the patron's virtual place in the queue line.

67. The system of claim 65, wherein the queuing system computer polls the local area network for the at least one patron's communications device and determines the location of the patron with respect to the attraction, the queuing system computer being programmed to then determine the time needed for the patron to return to the attraction and their respective place in the queue line and then notifies the patron, through the local area network, in advance of the time the patron needs to re-enter the queue line in order to enter the final assembly area of the attraction.

68. A queuing method for use in controlling the movement of a plurality of patrons through an attraction, the attraction having an attraction entrance, a final assembly area in which patrons gather immediately before boarding the attraction, and an attraction exit, said method comprising the steps of:
issuing a token to each patron of the attraction;
assigning a unique identifier to each said token;
scanning the patron's token at a first scanner positioned at the entrance to the attraction;
scanning the patron's token at a second scanner positioned at the final assembly area of the attraction;
scanning the patron's token at a third scanner positioned at the exit of the attraction; and
forwarding the scanned information from each said scanner to a queuing system computer in communication with each of said scanners, the queuing system computer assigning each successive patron of the attraction a sequential place in a single queue line therefor.

69. The method of claim 68, further comprising the step of selectively providing at least one of the patrons with a wireless personal tracking and communications device, said communications device being constructed and arranged to be in communication with the queuing system computer through a local area network also in communication with the queuing system computer, each said communications device emitting a signal adapted to be detected and read by each of said scanners and for being received by the local area network.

70. The method of claim 69, the queuing system computer assigning a virtual place in the queue line to each patron using one of said communications devices once that patron's communications device is scanned by said first scanner.

71. The method of claim 70, the queuing system computer tracking the progress of each patron with one of said communications devices through the queue line whether the patron is present in or absent from the queue line, and if absent from the queue line, holding a virtual place in the queue line for the patron.

72. The method of claim 70, the control computer polling the local area network for the patron's communications device, determining the location of the patron with respect to the attraction, the queuing system computer then determining the time needed for the patron to return to the attraction and their place in the queue line and then notifying the patron in advance of the time the patron needs to re-enter the queue line in order to be present to enter the final assembly area of the attraction.
